(19) United States
(12) Patent Application Publication
(10) Pub. No.: US 2025/0061345 A1
(43) Pub. Date: Feb. 20, 2025

(54) MODEL STABILITY DETECTION METHOD, APPARATUS, AND DEVICE

(71) Applicant: Beijing Volcano Engine Technology Co., Ltd., Beijing (CN)

(72) Inventors: Guolong Song, Beijing (CN); Xuan Luo, Beijing (CN)

(21) Appl. No.: 18/807,530

(22) Filed: Aug. 16, 2024

(30) Foreign Application Priority Data
Aug. 18, 2023 (CN) 202311048870.1

(51) Int. Cl. G06N 5/01

(52) U.S. Cl. CPC G06N 5/01

(57) ABSTRACT

Disclosed herein a model stability detection method and apparatus, and a device. Base period labeled samples and base period unlabeled samples at a base period time point, and current period unlabeled samples at a current period time point are obtained. A base period decision tree model is trained using the base period labeled samples. The base period decision tree model includes at least one path from a root node to a leaf node. Applying the base period decision tree model to form a first set of numerical values and second set of numerical values. Due to a distribution change of the input data in the samples, the sample statistics are different. Therefore, occurrence of data drift can be determined based on a first distribution difference result of the first set of numerical values and the second set of numerical values, to implement model stability detection.

### CROSS-REFERENCE TO RELATED APPLICATION(S)

This application claims priority to Chinese Application No. 202311048870.1 filed in Aug. 18, 2023, the disclosures of which are incorporated herein by reference in their entities.

### FIELD

the present disclosure generally relates to the technical field of computers, and more specifically, to a model stability detection method, apparatus, and device.

### BACKGROUND

During machine learning and deep learning, it is typical to train a model and apply the trained model to a specific application scenario. With the passage of time, the distribution of input data of the model may be changed, resulting in data drift; the relationship between the input data and the model target may also be changed, leading to concept drift.

As known in the art, data drift, concept drift, or the like, may undermine the stability of the trained model. Therefore, how to detect the stability of the trained model is an urgent problem to be solved.

### SUMMARY

In view of the above, the present disclosure provides a model stability detection method and apparatus, and a device, to detect stability of a trained model and determine a problem existing therein.

In order to solve the above problem, the present disclosure provides the following technical solution:

In a first aspect, the present disclosure provides a model stability detection method, comprising:
obtaining base period labeled samples and base period unlabeled samples at a base period time point, and current period unlabeled samples at a current period time point, the base period time point preceding the current period time point;
training a decision tree model based on the base period labeled samples, to obtain a base period decision tree model, the base period decision tree model comprising at least one path from a root node to a leaf node;
applying the base period decision tree model to predict the base period unlabeled samples, obtaining a first sample statistic corresponding to each of the at least one path after the predicting, and forming a first set of numerical values by first sample statistics corresponding to respective paths in the at least one path;
applying the base period decision tree model to predict the base period unlabeled samples, obtaining a second sample statistic corresponding to each of the at least one path after the predicting, and forming a second set of numerical values by second sample statistics corresponding to respective paths in the at least one path, the first sample statistic and the second sample statistic being of a same type; and
obtaining a first distribution difference result of the first set of numerical values and the second set of numerical values, and determining, in response to the first distribution difference result meeting a first preset condition, that data drift has occurred.

In a second aspect, the present disclosure provides a model stability detection apparatus, comprising:
a first obtaining unit for obtaining base period labeled samples and base period unlabeled samples at a base period time point, and current period unlabeled samples at a current period time point, the base period time point preceding the current period time point;
a training unit for training a decision tree model based on the base period labeled samples, to obtain a base period decision tree model, the base period decision tree model comprising at least one path from a root node to a leaf node;
a first predicting unit for applying the base period decision tree model to predict the base period unlabeled samples, obtaining a first sample statistic corresponding to each of the at least one path after the predicting, and forming a first set of numerical values by first sample statistics corresponding to respective paths in the at least one path forming;
a second predicting unit for applying the base period decision tree model to predict the base period unlabeled samples, obtaining a second sample statistic corresponding to each of the at least one path after the predicting, and forming a second set of numerical values by second sample statistics corresponding to respective paths in the at least one path, the first sample statistic and the second sample statistic being of a same type; and
a second obtaining unit for obtaining a first distribution difference result of the first set of numerical values and the second set of numerical values, and determining, in response to the first distribution difference result meeting a first preset condition, that data drift has occurred.

In a third aspect, the present disclosure provides an electronic device, comprising:
one or more processors; and
a memory having one or more programs stored thereon;
wherein the one or more programs, when executed by the one or more processors, cause the one or more processors to implement the model stability detection method as described above.

In a fourth aspect, the present disclosure provides a computer readable storage medium having a computer program stored thereon, wherein the computer program, when executed by a processor, implements the model stability detection method as described above.

In view of the above, the present disclosure has the following advantages:

In view of the above, embodiments of the present disclosure provide a model stability detection method and apparatus, and a device. base period labeled samples and base period unlabeled samples at a base period time point, and current period unlabeled samples at a current period time point are obtained, where the base period time point is before the current period time point. A decision tree model is trained based on the base period labeled samples, to obtain a base period decision tree model. The base period decision tree model includes at least one path from a root node to a leaf node. In order to detect whether sample data at the current period time point has drifted, the base period unlabeled samples are predicted using the base period decision tree model, a first sample statistic corresponding to each of the at least one path is obtained after the predicting, and a first set of numerical values is formed by first sample statistics corresponding to respective paths in the at least one path. The current period unlabeled samples are predicted using the base period decision tree model, a second sample statistic corresponding to each of the at least one path is obtained after the predicting, and a second set of numerical values is formed by second sample statistics corresponding to respective paths in the at least one path. Wherein, the first sample statistic and the second sample statistic are of a same type. A first distribution difference result of the first set of numerical values and the second set of numerical values is obtained, where the first distribution difference result can indicate a distribution difference between the first sample statistics and the second sample statistics corresponding to the respective paths, and it is determined that the data drift has occurred in response to the first distribution difference result meeting a first preset condition, i.e., it is determined that the sample data at the current period time point has drifted, as compared with the sample data at the base period time point, which undermines the stability of the model.

Data drift refers to that a distribution of input data of a model is changed over time. The input data corresponds to input data features that are internal nodes in paths of the base period decision tree model. When samples are predicted using the base period decision tree model, the predicting involves passing through input data features in the paths. When a distribution of the input data features is changed over time, the base period unlabeled samples and current period unlabeled samples may pass through different paths of the base period decision model, causing the sample statistic corresponding to the same path to be changed. Therefore, occurrence of data drift can be determined accurately based on a distribution difference result of first sample statistics and second sample statistics corresponding to respective paths, to thus implement model stability detection.

### BRIEF DESCRIPTION OF THE DRAWINGS

FIG. 1 illustrates a schematic diagram of a framework of an example application scenario provided by embodiments of the present disclosure;

FIG. 2 illustrates a flowchart of a model stability detection method provided by embodiments of the present disclosure;

FIG. 3 illustrates a schematic diagram of a base period decision tree model provided by embodiments of the present disclosure;

FIG. 4 illustrates a flowchart of a further model stability detection method provided by embodiments of the present disclosure;

FIG. 5 illustrates a schematic diagram of a structure of a model stability detection apparatus provided by embodiments of the present disclosure; and

FIG. 6 illustrates a schematic diagram of a basic structure of an electronic device provided by embodiments of the present disclosure.

### DETAILED DESCRIPTION OF EMBODIMENTS

In order to make the above objective, features and advantages of the present disclosure more apparent, detailed description on embodiments of the present disclosure will be described below with reference to the drawings and specific implementations.

For ease of understanding and explanation of the technical solution provided by embodiments of the present disclosure, description below will be first made on the technical background of the present disclosure.

It would be appreciated that, prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers, or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative, without constituting any limitation to the implementations of the present disclosure. Other methods compliant with the provisions of the relevant laws and regulations can also be applied to the implementations of the present disclosure.

Machine learning and deep learning typically include training a model, and using the trained model in a specific application scenario. For example, the model may be a model for predicting whether a watermelon is satisfactory, a model for predicting whether a product is of high quality, and the like. The model is typically employed to represent a mapping relationship between input data and output data, where the input data corresponds to input data features, and output data is output by the model after the input data are input into the model. The model for predicting whether a product is of high quality is taken as an example. The input data features of such model may include views, a click-through rate, and the like, and the output data includes two types of output results, namely a high quality product, and not a high quality product. In the case, the model obtained after training is completed can represent a mapping relationship between an input data feature of a product such as views, a click-through rate, or the like, and output data indicating whether the product is of high quality. In other words, after determining the views, the click-through rate, or the like, of the product, the model can determine whether the product is of high quality.

In general, a distribution of input data of a model may be changed over time, thus resulting in data drift. It would be appreciated that a model represents a mapping relationship between input data and output data during training. If the input data has drifted over time, the trained model would have a reduced prediction accuracy for the offset input data. The model for predicting whether a product is of high quality is taken as an example. The input data employed during model training includes views, a click-through rate, and the like, of the product, and since the product involved in the input data used for model training may be popular at that time, it has a great number of views and a high click-through rate (which could be considered as a high-quality product). As the time elapsed, the views and the click-through rate of the product are decreased since the product lost its popularity. At this time, if the product is predicted based on the trained model, the prediction accuracy is reduced.

The relationship between the input data and the model target may be changed over time, resulting in concept drift. The model target is output data (or an output result) of the model. That is, the mapping relationship between the input data and the output data of the model may be changed. Predicting whether a product is of high quality is taken as an example. During model training, if the product has more than 600 views per minute and the click-through of more than 400 per minute, it is determined that the product is of high quality. However, the manner of determining whether the product is of high quality is changed over time (which indicates that the relationship between the input data and the model target is changed). For example, if the product has more than 500 views per minute and the click-through of more than 300 per minute, the product can be determined as a high-quality product. Accordingly, the trained model has a lower prediction accuracy for the input data after concept drift occurred.

Data drift, concept drift, and the like, will cause a decrease in the stability of the trained model. Therefore, how to detect stability of a trained model is an urgent problem to be solved.

In view of the above, embodiments of the present disclosure provide a model stability detection method and apparatus, and a device. base period labeled samples and base period unlabeled samples at a base period time point, and current period unlabeled samples at a current period time point are obtained, where the base period time point is before the current period time point. A decision tree model is trained based on the base period labeled samples, to obtain a base period decision tree model. The base period decision tree model includes at least one path from a root node to a leaf node. In order to detect whether sample data at the current period time point has drifted, the base period unlabeled samples are predicted using the base period decision tree model, a first sample statistic corresponding to each of the at least one path is obtained after the predicting, and a first set of numerical values is formed by first sample statistics corresponding to respective paths in the at least one path. The current period unlabeled samples are predicted using the base period decision tree model, a second sample statistic corresponding to each of the at least one path is obtained after the predicting, and a second set of numerical values is formed by second sample statistics corresponding to respective paths in the at least one path. Wherein, the first sample statistic and the second sample statistic are of a same type. A first distribution difference result of the first set of numerical values and the second set of numerical values is obtained, where the first distribution difference result can indicate a distribution difference between the first sample statistics and the second sample statistics corresponding to the respective paths, and it is determined that the data drift has occurred in response to the first distribution difference result meeting a first preset condition, i.e., it is determined that the sample data at the current period time point has drifted, as compared with the sample data at the base period time point.

Data drift refers to that a distribution of input data of a model is changed over time. The input data corresponds to input data features that are internal nodes in paths of the base period decision tree model. When samples are predicted using the base period decision tree model, the predicting involves passing through input data features in the paths. When a distribution of the input data features is changed over time, the base period unlabeled samples and current period unlabeled samples may pass through different paths of the base period decision model, causing the sample statistic corresponding to the same path to be changed. Therefore, occurrence of data drift can be determined accurately based on a distribution difference result of first sample statistics and second sample statistics corresponding to respective paths, to thus implement model stability detection.

It would be appreciated that the deficiencies of the above-mentioned solution were found in practice by the applicants after careful study. Therefore, the discovery process of the above-mentioned problem and the solution according to embodiments of the present disclosure proposed to solve the above-mentioned problem should all be the contributions made by the applicants to the embodiments of the present disclosure.

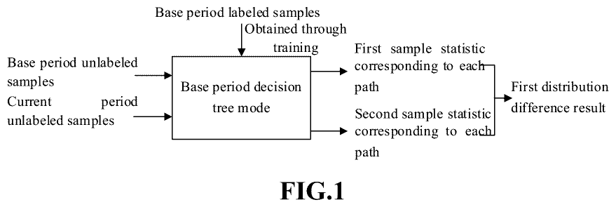

For ease of understanding on the model stability detection method provided by the embodiments of the present disclosure, description will be made below with reference to an example scenario shown in FIG. 1. FIG. 1 is a schematic diagram of a framework of an example application scenario provided by embodiments of the present disclosure. The method can be applied in a terminal device and/or a server, which is not limited herein. The terminal device includes, but is not limited to, a smart phone, a tablet, a laptop, a smart watch, or the like. The server may be an independent physical server, or may be a server cluster or distributed system comprised of a plurality of physical servers, or may be a cloud server capable of providing basic cloud computing services such as cloud service, could databases, cloud computing, cloud storage, big data, artificial intelligence platforms, and the like. Specifically, the method can be applied to a backend of a target application installed in the terminal device and/or the server. The target application is an application installed in the terminal device and/or the server, which is not limited therein.

In the actual use, the terminal device and/or server acquires base period labeled samples and base period unlabeled samples at a base period time point, and current period unlabeled samples at a current period time point. The base period time point is before the current period time point. Samples at the base period time point include base period labeled samples and base period unlabeled samples. The current period unlabeled samples at the current period time point belong to samples at the current period time point. The samples at the base period time point and the samples at the current period time include the same input data features. The terminal device and/or the server trains a decision tree model based on the base period labeled samples, to obtain a base period decision tree model. The base period decision tree model includes at least one path from a root node to a leaf node. The predicting using the base period decision tree model includes executing/passing through the paths in the base period decision tree model.

The terminal device and/or the server predicts base period unlabeled samples using the base period decision tree model, where the predicting includes executing the paths in the base period decision tree model, and a first sample statistic corresponding to each path is obtained after the predicting. First sample statistics corresponding to respective paths form a first set of numerical values. In addition, the terminal device and/or the server predicts current period unlabeled samples using the base period decision tree model, where the predicting includes executing paths in the base period decision tree model, and a second sample statistic corresponding to each path is obtained after the predicting. Second sample statistics corresponding to respective paths form a second set of numerical values.

In order to detect whether sample data at the current period time point has drifted, the terminal device and/or the server acquires a first distribution difference result of the first set of numerical values and the second set of numerical values. Based on the first distribution difference result can be determined whether data drift has occurred. For example, when the first distribution difference result meets a first preset condition, it is determined that data drift has occurred.

It would be appreciated by those skilled in the art that the schematic diagram of the framework as shown in FIG. 1 is only an example where implementations of the present disclosure can be implemented. The application range of the implementations of the present disclosure is not limited by the framework in any aspect.

For ease of understanding of the present disclosure, reference below will be made to the drawings to describe a model stability detection method provided by embodiments of the present disclosure.

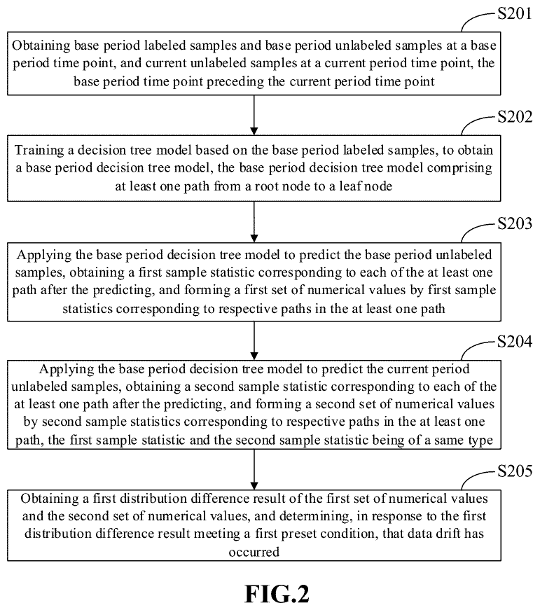

FIG. 2 is a flowchart of a model stability detection method provided by embodiments of the present disclosure. As shown therein, the method may include S201-S205:

S201: obtaining base period labeled samples and base period unlabeled samples at a base period time point, and current period unlabeled samples at a current period time point, where the base period time point is before the current period time point.

In order to detect stability of a model, it is required to determine whether data drift has occurred between input data used during model training and input data to be predicted after model deployment, and/or determine whether concept drift has occurred between input data used during model training and input data to be predicted after model deployment.

On the basis, it is required to compare input data and/or model effects at two time points. In the embodiments of the present disclosure, the two time points are a base period time point and a current period time point, respectively. Wherein, the base period time point is a previous time point, i.e., the base period time point is before the current period time point. It would be appreciated that time lengths indicated by the base period time point and the current period base point are not limited herein. For example, the base period time point and the current period time point may be two moments, or may be two time periods. Neither is limited herein a time interval between the base period time point and the current period time point, which can be determined according to the actual condition.

The labeled samples acquired at the base period time point are referred to as base period labeled samples. Unlabeled samples acquired through actual online use of the model at the base period time point are referred to as base period unlabeled samples. In addition, labeled samples acquired at the current period time point are referred to as current period labeled samples. Unlabeled samples acquired through actual online use of the model at the current period time point are referred to as current period unlabeled samples. The labeled samples and the unlabeled samples differ in that: the unlabeled samples (e.g. the base period unlabeled samples and the current period unlabeled samples) include input data; in contrast, the labeled samples (e.g. base period labeled samples and current period labeled samples) include labels corresponding to input data, in addition to the input data.

In order to attain a higher accuracy of detecting the model stability, the numbers of the base period labeled samples, the base period unlabeled samples, the current period labeled samples, and the current period unlabeled samples may be as great and as consistent as possible. However, the numbers of the base period labeled samples, the base period unlabeled samples, the current period labeled samples, and the current period unlabeled samples are not limited herein, i.e., it is allowed that the numbers of the base period labeled samples, the base period unlabeled samples, the current period labeled samples, and the current period unlabeled samples may be different from one another.

In the embodiments of the present disclosure, irrespective of being used at the base period time point or the current period of time point, or irrespective of being used for model training or model prediction, all of the data is referred to as sample data, abbreviated as samples. The sample data includes input data. It would be appreciated that, during model training, input data in the base period labeled labels are used to train the model. During model prediction (i.e., the model is used for prediction after model deployment), the trained model is used to predict input data (e.g. the base period unlabeled samples and/or the current period unlabeled samples) in the unlabeled sample data.

The input data corresponds to input data features. The input data features are data obtained after feature-representing (e.g. vector-representing) the input data, which is not limited herein. It would be appreciated that, irrespective of the base period time point or the current period time point, or irrespective of the application to model training or model prediction, the input data features in the sample data are the same, except the only difference in feature value. For example, when the model is used to predict a product of high quality, the input data features include views, a click-through rate, and the like. In the case, the views, the click-through rates, and the like may be different at the current period time point and the base period time point.

S202: training a decision tree model based on the base period labeled samples, to obtain a base period decision tree model, where the base period decision tree model includes at least one path from a root node to a leaf node.

In the embodiments of the present disclosure, the model to be detected for stability specifically refers to a model obtained through training based on the base period labeled samples. Since the stability of the model is related to data drift, concept drift, and the like, which may occur as the time elapses, it is required to detect whether data drift occurs to a distribution of input data, and whether concept drift occurs to the mapping relationship between the input data and the output data.

In view of the above, the model to be detected for stability may be a base period decision tree in the step, or may be other model (e.g. other neural network model, or the like) obtained through training based on the base period labeled samples. It would be appreciated that, regardless of whether the model to be detected for stability is the base decision tree model in the step, or other model obtained through training based on the base period labeled samples, the base period decision tree model in the step plays the role of detecting the model stability.

In addition to the input data, the labeled samples (e.g. the base period labeled samples and the current period labeled samples) include labels corresponding to the input data. For example, when the input data are views, a click-through rate, and the like, of a product, the label corresponding thereto may be of two types, including a high-quality product, or not a high-quality product. When training a decision tree model based on base period labeled samples, the input data in the base period labeled samples and the label corresponding to the input data are jointly used, to obtain the base period decision tree model.

The decision tree model is of a tree structure, including inner nodes and leaf nodes. An output result corresponding to the output data can be predicted based on the decision tree model. The decision tree model includes a classification tree model and a regression tree model, which is not limited herein. For example, in order to handle a classification problem, the decision tree model is used to classify input data features, where a leaf node represents a category.

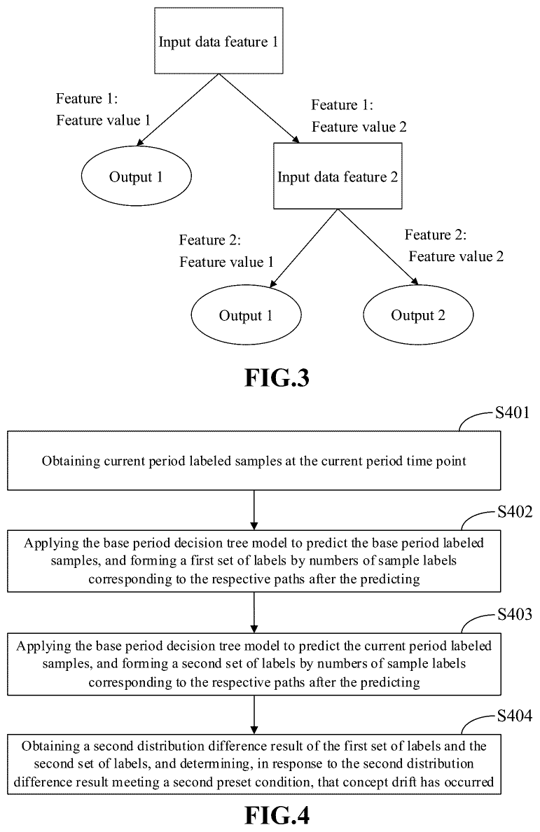

FIG. 3 is a schematic diagram of a base period decision tree model provided by embodiments of the present disclosure. FIG. 3 is provided only as an example for illustration, without constituting any limitation. As shown therein, a box is an inner node of the base period decision tree model, and an ellipse is a leaf node of the base period decision tree model. The inner nodes include an input data feature 1 and an input data feature 2. The leaf nodes include an output 1 and an output 2. If the base period decision tree is a classification tree, the output 1 and the output 2 are two types of classification results. For example, when determining quality of a product, the input data feature 1 is views, the input data feature 2 is a click-through rate, the output 1 is high-quality product, and the output 2 is not high-quality product. It would be appreciated that the output 1 corresponds to label 1 (for example, all are high-quality products), and the output 2 corresponds to label 2 (for example, none is high-quality product). Only the output 1 and the output 2 are the output results of the base period decision tree model, which are predictive values, and the label is an actual expected result, which is applied to the training process of the base period decision tree model.

When predicting the input data based on the base period decision tree model, conditional determining is performed. As shown in FIG. 3, whether the input data feature 1 in the input data meets a feature value 1 is determined. If the feature value of the input data feature 1 meets the feature value 1 of the input data feature 1, an output 1 is obtained. Otherwise, if the feature value of the input data feature 1 is a feature value 2 of the input data feature 1, determining the input data feature 2 in the input data is performed. If the feature value of the input data feature 2 is a feature value 1 of the input data feature 2, an output 2 is obtained. It is to be understood that the determining condition in the base period decision tree model may be a feature value range, which is not limited herein.

The base period decision tree model includes at least one path from a root node to a leaf node. The number of paths is equal to the number of leaf nodes. The base period decision tree model as shown in FIG. 3 includes three paths, specifically: a first path (path 1) which is a path from the input data feature 1 to the output 1; a second path (path 2) which is a path from the input data feature 1 to the input data feature 2, and further to the output 1; and a third path (path 3) which is a path from the input data feature 1 to the input data feature 2, and further to the output 2.

As an optional example, each path from a root node to a leaf node of the base period decision tree model can be numbered. For example, the paths are numbered as path_0, path_1, . . . , path_n, where n is a number of paths, which is a positive integer. In this way, the three paths in FIG. 3 can be numbered as path_1, path_1, and path_2, which represent the path 1, the path 2, and the path 3, respectively. In addition, path_x may be used to represent any of the paths.

On each path of the base period decision tree model, there is provided at least one individual feature and/or at least one cross feature corresponding thereto. The path and the individual feature and/or the cross feature on the path are associated with each other. Wherein, the individual feature is an input data feature, and the cross feature may be read as a combination feature, specifically a combination feature of the input data features. As shown in FIG. 3, on the first path, the individual feature is the input data feature 1. On the second path, there is a combination feature formed by the input data feature 1 and the input data feature 2, and the input data features associated with the second path include the input data feature 1, and the input data feature 2. The second path is associated with the cross feature comprised of the input data feature 1, and the input data feature 2.

S203: applying the base period decision tree model to predict the base period unlabeled samples, obtaining a first sample statistic corresponding to each of the at least one path after the predicting, and forming a first set of numerical values by first sample statistics corresponding to respective paths in the at least one path.

Subsequent to obtaining the base period decision tree model, the respective base period unlabeled samples are predicted using the base period decision tree model, which actually means that input data in the respective base period unlabeled samples is predicted. During prediction, conditional determining is performed in the base period decision tree model for input data of each base period unlabeled sample, and the base period unlabeled sample finally arrives at a leaf node of the path. After the predicting is completed, each base period unlabeled sample corresponds to a path in the base period decision tree model. The same path may correspond to one or more base period unlabeled samples.

For example, the execution path corresponding to the base period unlabeled sample 1 is the path 1, the execution path corresponding to the base period unlabeled sample 2 is the path 1, the execution path corresponding to the base period unlabeled sample 3 is the path 2, the execution path corresponding to the base period unlabeled sample 4 is the path 3, the execution path corresponding to the base period unlabeled sample 5 is the path 3, and the like.

In this way, a sample statistic corresponding to each path after predicting the base period unlabeled samples can be obtained, which is also referred to as first sample statistic, and a first set of numerical values is formed by first sample statistics corresponding to the respective paths. Moreover, the first set of numerical values may also include serial numbers of the paths. That is, the first set of numerical values may include the serial numbers of the paths, and the first sample statistics corresponding to the respective paths (also referred to as first sample statistics respectively corresponding to the serial numbers of the paths). In the first set of numerical values, the respective first sample statistics can be presented according to the serial numbers of the paths.

Wherein, a first sample statistic corresponding to a path is used to indicate a status of a number of base period unlabeled samples executing the path during prediction.

As an optional example, the first sample statistic corresponding to the path is a number of base period unlabeled samples executing the path. Accordingly, the number of base period unlabeled samples executing the path can indicate the status of the number of base period unlabeled samples.

As a further optional example, the first sample statistic corresponding to the path may be a proportion of a number of base period unlabeled samples executing the path to a total number of the base period unlabeled samples. Accordingly, the proportion can indicate the status of the number of base period unlabeled samples executing the path.

In view of the above, the embodiments of the present disclosure provide a specific implementation of obtaining the first sample statistic corresponding to each of the at least one path after the predicting, and forming the first set of numerical values by the first sample statistics corresponding to respective paths in the at least one path, including:
calculating a first proportion corresponding to each of the at least one path after the predicting, and forming the first set of numerical values by first proportions corresponding to respective paths in the at least one path, where the first proportion corresponding to the path is a proportion of a number of base period unlabeled samples passing through the path to a total number of the base period unlabeled samples after the predicting.

In the case that path_x represents any of the paths, a first proportion corresponding to the path_x is a quotient obtained by dividing the number of base period unlabeled samples passing through the path by the total number of base period unlabeled samples. The first proportion corresponding to the path_x may be read as a proportion of base period unlabeled samples executing the path_x during prediction.

It would be appreciated that, as compared with the case of using the number of base period unlabeled samples executing the path to represent the first sample statistic, the proportion can directly demonstrate a distribution of unlabeled samples executing each path, and if the first proportion is used to represent the first sample statistic and applied in the subsequent difference comparison, a more accurate model stability detection result will be attained.

S204: applying the base period decision tree model to predict the current period unlabeled samples, obtaining a second sample statistic corresponding to each of the at least one path after the predicting, and forming a second set of numerical values by second sample statistics corresponding to respective paths in the at least one path, where the first sample statistic and the second sample statistic are of a same type.

In order to implement model stability detection, it is further required to predict the respective current period unlabeled samples using the base period decision tree model. Like S203, after the predicting is completed, each current period unlabeled sample corresponds to a path in the base period decision tree model. The same path may correspond to one or more current period unlabeled samples.

In this way, a sample statistic corresponding to each path after predicting the current period unlabeled samples can be obtained, which is also referred to as second set of numerical values. Moreover, the second set of numerical values may further include serial numbers of the paths. That is, the second set of numerical values may include the serial numbers of the paths, and the second sample statistics corresponding to the respective paths (also referred to as second sample statistics respectively corresponding to the serial numbers of the paths). In the second set of numerical values, the respective second sample statistics can be presented according to the serial numbers of the paths.

Wherein, a second sample statistic corresponding to a path is used to indicate a status of a number of current period unlabeled samples executing the path during prediction.

As an optional example, the second sample statistic corresponding to the path is a number of current period unlabeled samples executing the path.

As a further optional example, the second sample statistic corresponding to the path may be a proportion of the number of current period unlabeled samples executing the path to a total number of the current period unlabeled samples.

In view of the above, the embodiments of the present disclosure provide a specific implementation of obtaining the second sample statistic corresponding to each of the at least one path after the predicting, and forming the second set of numerical values by the second sample statistics corresponding to respective paths in the at least one path, including:
calculating a second proportion corresponding to each of the at least one path after the predicting, and forming the second set of numerical values by second proportions corresponding to respective paths in the at least one path, where the second proportion corresponding to the path is a proportion of a number of current period unlabeled samples passing through the path to a total number of the current period unlabeled samples after the predicting.

In the case that path_x represents any of the paths, a second proportion corresponding to the path_x is a quotient obtained by dividing the number of current period unlabeled samples passing through the path by the total number of current period unlabeled samples. The second proportion corresponding to the path_x may be read as a proportion of current period unlabeled samples executing the path_x during prediction.

It would be appreciated that, as compared with the case of using the number of current period unlabeled samples executing the path to represent the first sample statistic, the proportion can directly demonstrate a distribution of unlabeled samples used on each path, and if the second proportion is used to represent the second sample statistic and applied in the subsequent difference comparison, a more accurate model stability detection result can be attained.

S205: obtaining a first distribution difference result of the first set of numerical values and the second set of numerical values, and determining, in response to the first distribution difference result meeting a first preset condition, that data drift has occurred.

The first distribution difference result of the first set of numerical values and the second set of numerical values is mainly a distribution difference result of the first sample statistics corresponding to the respective paths in the first set of numerical values and the second sample statistics corresponding to the respective paths in the second set of numerical values.

It would be appreciated that, when the distribution of the input data features is changed over time, the base period unlabeled samples and the current period unlabeled samples may pass through different paths of the base period decision tree model, leading to a change in the sample statistic corresponding to the same path. Therefore, occurrence of data drift can be determined accurately based on the distribution difference result of the first sample statistics and the second sample statistics corresponding to the respective paths. For example, when the first distribution difference result meets a first preset condition, a model stability problem caused by data drift is determined. The data drift refers to that a distribution of sample data at the current period time point is changed over time, as compared with the sample data at the base period time point.

In a possible implementation, the embodiments of the present disclosure provide a specific manner of obtaining the first distribution difference result of the first set of numerical values and the second set of numerical values, and determining, in response to the first distribution difference result meeting the first preset condition, that the data drift has occurred, comprising:
calculating a first KL divergence of the first set of numerical values and the second set of numerical values based on the first sample statistics corresponding to the respective paths in the first set of numerical values and the second sample statistics corresponding to the respective paths in the second set of numerical values; and determining, in response to the first KL divergence meeting a first threshold range, that data drift has occurred.

The KL divergence may also be called KL distance or relative entropy. In the embodiments of the present disclosure, the KL divergence may be used to measure a difference between two distributions. That is, the first KL divergence acts as the first distribution difference result for measuring a distribution difference between the first sample statistics and the second sample statistics corresponding to the respective paths. When the first distribution difference result is the first KL divergence, the first preset condition is that the first KL divergence meets a first threshold range.

Specifically, the computing formula of the KL divergence is:

$${D}_{K L} ( P ‖ Q ) = {\sum }_{i = 1}^{n} {P}_{i} log ( {P}_{i} / {Q}_{i} )$$

where P and Q are two distributions, respectively, i is each possible event, D_{KL}(P∥Q) is a KL divergence, and Pᵢ and Qᵢ are probabilities of the event i in the distributions P and Q.

In the embodiments of the present disclosure, each path path_x may be of a value of i. For example, the total number of the paths is 3, where i is valued to 1, 2, or 3. The first sample statistic corresponding to the path_x is substituted for Pᵢ, and the second sample statistic corresponding to the path_x is substituted for Qᵢ into the computing formula, to compute the first KL divergence.

A greater first KL divergence indicates a greater difference between the first set of numerical values and the second set of numerical values. As an optional example, a first KL threshold is set, and the first threshold range is greater than the range of the first KL threshold.

In addition, a Maximum Mean Difference (MMD) may be used to indicate the first distribution difference result of the first set of numerical values and the second set of numerical values. The Maximum Mean Difference MMD can also be used to measure a similarity (or a difference) between two distributions, which is not limited herein.

As an optional example, when the first sample statistic is the first proportion, and the second sample statistic is the second proportion, the first KL divergence between the first set of numerical values and the second set of numerical values is computed based on the first sample statistics corresponding to the respective paths in the first set of numerical values and the second sample statistics corresponding to the respective paths in the second set of numerical values. Specifically, the first KL divergence between the first set of numerical values and the second set of numerical values is computed based on the first proportion and the second proportion corresponding to the respective paths. In the example, the first proportion corresponding to the path_x is substituted for Pᵢ, and the second proportion corresponding to the path_x is substituted for Qᵢ into the computing formula, to compute the first KL divergence.

By way of example, both the number of the base period unlabeled samples and the number of the current period unlabeled samples are 1000. As shown in FIG. 3, the paths are path_0, path_1, and path_2, i.e., i is valued to 1, 2 or 3. In S203, the number of the base period unlabeled samples executing the path_0 is 200, the number of the base period unlabeled samples executing the path_1 is 300, and the number of the base period unlabeled samples executing the path_2 is 500. In the case, the first proportion corresponding to the path_0 is 200/1000=0.2, the first proportion corresponding to the path_1 is 0.3, and the first proportion corresponding to the path_2 is 0.5. In S204, the number of the base period unlabeled samples executing the path_0 is 400, the number of the base period unlabeled samples executing the path_1 is 400, and the number of the base period unlabeled samples executing the path_2 is 200. In the case, the first proportion corresponding to the path_0 is 0.4, the first proportion corresponding to the path_1 is 0.4, and the first proportion corresponding to the path_2 is 0.2. The first KL divergence can be computed by substituting respective values into the formula for computing the KL divergence.

From the above description related to steps S201-S205, the present disclosure provides a model stability detection method, including: obtaining base period labeled samples and base period unlabeled samples at a base period time point, and current period unlabeled samples at a current period time point, where the base period time point is before the current period time point; training a decision tree model based on the base period labeled samples, to obtain a base period decision tree model, where the base period decision tree model includes at least one path from a root node to a leaf node; in order to detect whether sample data at the current period time point has drifted, applying the base period decision tree model to predict the base period unlabeled samples, obtaining a first sample statistic corresponding to each of the at least one path after the predicting, and forming a first set of numerical values by first sample statistics corresponding to respective paths in the at least one path; applying the base period decision tree model to predict the current period unlabeled samples, obtaining a second sample statistic corresponding to each of the at least one path after the predicting, and forming a second set of numerical values by second sample statistics corresponding to respective paths in the at least one path, where the first sample statistic and the second sample statistic are of a same type; and obtaining a first distribution difference result of the first set of numerical values and the second set of numerical values, where the first distribution difference result can indicate a distribution difference between the first sample statistics and the second sample statistics corresponding to the respective paths, and determining, in response to the first distribution difference result meeting a first preset condition, that data drift has occurred, i.e., determining that the sample data at the current period time point has drifted, as compared with the sample data at the base period time point, which undermines the stability of the model.

Data drift refers to that a distribution of input data of a model is changed over time. The input data corresponds to input data features that are internal nodes in paths of the base period decision tree model. When samples are predicted using the base period decision tree model, the predicting involves passing through input data features in the paths. When a distribution of the input data features is changed over time, the base period unlabeled samples and current period unlabeled samples may pass through different paths of the base period decision model, leading to a change in the sample statistic corresponding to the same path. Therefore, occurrence of data drift can be determined accurately based on a distribution difference result of the first sample statistics and the second sample statistics corresponding to respective paths, to thus implement model stability detection.

In view of the above, the model stability problem caused by occurrence of data drift can be determined. On the basis, feature attribution can also be performed, which involves the input data features that bring about the data drift.

In a possible implementation, the model stability detection method provided by the embodiments of the present disclosure may further includes the following steps:

A1: calculating a difference between the first proportion and the second proportion corresponding to each of the at least one path.

As an optional example, when the first sample statistic corresponding to the path is a number of base period unlabeled samples executing the path, and the second sample statistic corresponding to the path is a number of base period unlabeled samples executing the path, the difference is the one between the two numbers.

As another optional example, when the first sample statistic is a first proportion, and the second sample statistic is a second proportion, the difference is the one between the two proportions. On the basis, the step A1 specifically includes calculating a difference between a first proportion and a second proportion corresponding to each path.

For any path path_x, the difference between the first proportion and the second proportion thereof may be represented by path_x_diff. In the case, path_x_diff=|first proportion−second proportion|, where |·| is an absolute value.

A2: determining a path with the difference meeting a difference range as a first target path, and determining that input data features associated with the first target path are related to the data drift.

As an optional example, when the first sample statistic corresponding to the path is a number of base period unlabeled samples executing the path, and the second sample statistic corresponding to the path is a number of current period unlabeled samples executing the path, the difference range is a number range. A number threshold can be set, where the number range is a range greater than the number threshold range.

As another optional example, when the first sample statistic is a first proportion, and the second sample statistic is a second proportion, the difference range is a proportion range. A proportion threshold can be set, where the number range is a range greater than the proportion threshold range.

Each path corresponds to a difference obtained through calculating, a difference meeting the difference range is determined from a plurality of differences, and a path corresponding to the difference is determined as a first target path. It would be appreciated that a greater difference indicates a greater change of samples executing the path, which may be due to the fact that the distribution of input data features on the path has changed. Therefore, the input data features associated with the first target path are related to data drift, and further, the individual features, cross features, and the like, associated with the first target path may be a cause of the model instability. The number of the first target paths may be one or more. When the number of the first target paths is multiple, the difference corresponding to the path has a greater value, and the input data features associated with the path have a more significant impact on data drift.

From the above description related to steps of A1-A2, the embodiments of the present disclosure cannot only detect accurately the model stability problem caused by data drift, but can also attribute features to data drift, to determine the input data features leading to data drift.

In view of the above, the present disclosure can implement model stability detection, and fulfil feature attribution for data drift by providing a method for determining data drift. However, the model stability is still related to concept drift. Hereinafter, reference will be made to the drawings to describe a method for determining concept drift.

FIG. 4 illustrates a flowchart of a further model stability detection method provided by embodiments of the present disclosure. As shown therein, the method includes S401-S404:

S401: obtaining current period labeled samples at the current period time point.

From the above description about S201, it could be learned that the labeled samples obtained at the current period time point is referred to as current period labeled samples.

S402: applying the base period decision tree model to predict the base period labeled samples, and forming a first set of labels by numbers of sample labels corresponding to respective paths after the predicting.

Subsequent to obtaining the base period decision tree model, the base period labeled samples are predicted using the base period decision tree model, which actually means that input data in the base period labeled samples is predicted. Likewise, the predicting includes executing corresponding paths. After the predicting is completed, each base period labeled sample corresponds to a path in the base period decision tree model. The same path may correspond to one or more base period labeled samples. Since the base period labeled samples include therein labels of input data, it can be regarded that each path may correspond to labels of one or more pieces of input data. It would be appreciated that, during classification, since a leaf node corresponding to a path represents only one category, the labels of the one or more pieces of input data corresponding to each path should be of the same type. Therefore, a number of labels of input data corresponding to each path, namely a number of sample labels, can be aggregated.

As such, the number of sample labels corresponding to the path is equal to the number of base period labeled samples corresponding to the path. For example, the base period decision tree model as shown in FIG. 3 is used to predict a base period labeled sample 1, a base period labeled sample 2, a base period labeled sample 3, and a base period labeled sample 4. After the predicting is completed, the base period labeled sample 1 corresponds to the path 1, the base period labeled sample 2 corresponds to the path 1, the base period labeled sample 3 corresponds to the path 2, and the base period labeled sample 4 corresponds to the path 3. The labels corresponding to the path 1 are label 1, and the corresponding number of sample labels is 2; the labels corresponding to the path 2 are label 1, and the corresponding number of sample labels is 1; the labels corresponding to the path 3 are label 2, and the corresponding number of sample labels is 1.

The first set of labels further includes serial numbers of paths. That is, the first set of labels may include serial numbers of the paths, and numbers of sample labels corresponding to the respective paths (also referred to as numbers of sample labels corresponding to respective serial numbers of the respective paths) after predicting the base period labeled samples. In the first set of labels, the corresponding numbers of sample labels can be presented according to the serial numbers of the paths.

S403: applying the base period decision tree model to predict the current period labeled samples, and forming a second set of labels by numbers of sample labels corresponding to respective paths after the predicting.

Subsequent to obtaining the base period decision tree model, the current period unlabeled samples are predicted using the base period decision tree model, which actually means that input data in the current period labeled samples is predicted. After the predicting is completed, each current period labeled sample corresponds to a path in the base period decision tree model. The same path may correspond to one or more current period labeled samples. Considering that the current period labeled samples include therein labels of input data, a number of labels of input data corresponding to each path, i.e., a number of sample labels, can also be aggregated. In the step, the number of sample labels corresponding to the path is equal to the number of current period labeled samples corresponding to the path.

The second set of labels further includes serial numbers of paths. That is, the second set of labels may include serial numbers of the paths, and numbers of sample labels corresponding to the respective paths (also referred to as numbers of sample labels corresponding to respective serial numbers of the respective paths) after predicting the base period labeled samples. In the second set of labels, the corresponding numbers of sample labels can be presented according to the serial numbers of the paths.

S404: obtaining a second distribution difference result of the first label set and the second label set, and determining, in response to the second distribution difference result meeting a second preset condition, that concept drift has occurred.

The second distribution difference result of the first set of labels and the second set of labels is mainly a distribution difference result of the set of sample labels corresponding to the respective paths in the first set of labels and the set of sample labels corresponding to the respective paths in the second set of labels.

It would be appreciated that, when the mapping relationship between the input data and the model output data is changed as time passed from the base period time point to the current period time point, the input data in the base period labeled samples and the input data in the current period labeled samples arrive at different leaf nodes after passing through the base period decision tree model, i.e., the output results obtained are different, which could also be read as that the corresponding labels are different (in the labeled samples, the output results and the labels are identical). As such, the number of sample labels corresponding to the same path is changed. Therefore, occurrence of concept drift can be determined accurately based on the number of the sample labels corresponding to the respective paths in the first set of labels and the number of the sample labels corresponding to the respective paths in the second set of labels, to thus implement model stability detection.

For example, when the second distribution difference result meets a second preset condition, it is determined that concept drift has occurred. The concept drift refers to that a distribution of the mapping relationship between the unlabeled sample data at the current period time point and the output data of the baes period decision tree model is changed over time, as compared with the mapping relationship between the unlabeled sample data at the base period time point and the output data of the base period decision tree model. Wherein, the output data of the base period decision tree model is obtained after the unlabeled sample data is input into the base period decision tree model.

From the above description about S401-S404, it could be learned that the embodiments of the present disclosure cannot only detect the model stability problem caused by data drift, but can also detect the model stability problem caused by concept drift. In this way, the cause of the model stability problem can be determined more accurately.

In a possible implementation, the embodiments of the present disclosure provide the specific implementing of step S404 of obtaining a second distribution difference result of the first set of labels and the second set of labels, and determining, in response to the second distribution difference result meeting a second preset condition, that concept drift has occurred, including:

B1: calculating a third proportion of the number of sample labels corresponding to each of the at least one path in the first set of labels to a total number of the base period labeled samples.

As shown in FIG. 3, if the base period decision tree model predicts a base period labeled sample 1, a base period labeled sample 2, a base period labeled sample 3, and a base period labeled sample 4, the total number of the base period labeled samples is 4. After the predicting is completed, the base period labeled sample 1 corresponds to the path 1, the base period labeled sample 2 corresponds to the path 1, the base period labeled sample 3 corresponds to the path 2, and the base period labeled sample 4 corresponds to the path 3. The labels corresponding to the path 1 are label 1, and the corresponding number of sample labels is 2; the labels corresponding to the path 2 are label 1, and the corresponding number of sample labels is 1; the labels corresponding to the path 3 are label 2, and the corresponding number of sample labels is 1. In the circumstance, the third proportion corresponding to the path 1 is ½. The rest are similar, and details are omitted herein for brevity.

B2: calculating a fourth portion of the number of sample labels corresponding to each path to a total number of the current period labeled samples.

The calculating process of a fourth proportion is similar to that of the third proportion, and details are omitted herein for brevity.

B3: calculating a second KL divergence corresponding to each path, based on the third proportion and the fourth proportion corresponding to each path.

It would be appreciated that the computing formula of the second KL divergence is similar to the one described in the above embodiment. Specifically, it is only required to substitute the third proportion corresponding to the path_x for Pᵢ, and the fourth proportion corresponding to the path_x for Qᵢ into the computing formula. The obtained KL divergence is the second KL divergence.

B4: selecting a maximum KL divergence in second KL divergences corresponding to respective paths.

Subsequent to calculating the second KL divergences corresponding to each path, the respective second KL divergences are compared, to obtain a maximum KL divergence. It would be appreciated that the maximum KL divergence is the second distribution difference result.

B5: determining the concept drift has occurred if the maximum KL divergence meets a second threshold range.

As an optional example, a second KL threshold is set, where a second threshold range is greater than a second KL threshold range. The relationship between the first KL threshold and the second KL threshold, or the relationship between the first threshold range and the second threshold range is limited herein, which can be set according to the actual needs.

In the step, the maximum KL divergence is used to measure a distribution difference between the third proportion and the fourth proportion corresponding to the respective paths. When the maximum KL divergence meets the second threshold range, which indicates a great distribution divergence, it is determined that concept drift has occurred.

Based on the steps B1-B5, the embodiments of the present disclosure provide a specific manner of obtaining a second distribution difference result based on the first set of labels and the second set of labels, i.e., distribution comparison can be performed between a proportion of a number of sample labels corresponding to respective paths to a total number of base period labeled samples and a proportion of a number of sample labels corresponding to respective paths to a total number of current period labeled samples, where a distribution comparison result is represented by a KL divergence, to determine whether concept drift has occurred.

In view of the above, the model stability problem caused by occurrence of data drift can be determined. On the basis, feature attribution can also be performed, which involves the input data features that bring about data drift.

In a possible implementation, the model stability detection method provided by the embodiments of the present disclosure further includes the following steps:

C1: determining a second target path corresponding to the maximum KL divergence.

It would be appreciated that each path corresponds to a second KL divergence. A maximum KL divergence is selected from the respective second KL divergences, and a path corresponding to the maximum KL divergence is determined as a second target path.

C2: determining that input data features associated with the second target path are related to the concept drift if the maximum KL divergence meets a third threshold range.

Since the second KL divergence corresponding to the second target path is greatest, which indicates the greatest change in the mapping relationship between the input data executing the path at the base period time point and the current period time point and the output data of the base period decision tree model, the second target path has the greatest impact on causing concept drift. Further, the individual features, the cross features, and the like, associated with the second target path, may be a cause for the model instability.

As a possible example, a third threshold is set, where a third threshold range is greater than a third KL threshold range.

From the above description about C1-C2, the embodiments the embodiments of the present disclosure cannot only detect accurately the model stability problem caused by data drift, but can also attribute features to data drift, to determine the input data features leading to data drift.

In a possible implementation, the embodiments of the present disclosure further provide a specific implementation of the step S404 of obtaining a second distribution difference result of the set of first labels and the second set of labels, and determining, in response to the second distribution difference result meeting a second preset condition, that concept drift has occurred, including:
calculating a fifth proportion corresponding to each type of sample labels in the first set of labels, and calculating a sixth proportion corresponding to each type of sample labels in the second set of labels, where the fifth proportion is a proportion of the number of sample labels in the first set of labels to the total number of base period labeled samples, and the sixth proportion is a proportion of the number of sample labels in the second set of labels to the total number of the current period labeled samples;
calculating, based on the fifth proportion and the sixth proportion, a third KL divergence between the first set of labels and the second set of labels;
if the third KL divergence meets a fourth threshold range, determining that concept drift has occurred.

As described above, the number of sample labels of each type in the first set of labels and the second set of labels can be aggregated, and the fifth proportion and the sixth proportion are computed. Wherein, the number of sample labels of each type is obtained from the number of sample labels corresponding to the respective paths. For example, as shown in FIG. 3, the labels corresponding to the path 1 in the first set of labels are label 1, and the corresponding number of sample labels is 2; the labels corresponding to the path 2 are label 1, and the corresponding number of sample labels is 1; the labels corresponding to the path 3 are label 2, and the corresponding number of sample labels is 1. In the circumstance, the fifth proportion corresponding to the path 1 in the first set of labels is ¾ (i.e., the number of sample labels corresponding to the path 1 and the number of sample labels corresponding to the path 2 are summed, and a quotient obtained by dividing the sum by the number of base period labeled samples is the fifth proportion), and the fifth proportion corresponding to the label 2 is ¼.

When calculating the third divergence based on the fifth proportion and the sixth proportion, the computing formula of the third KL divergence is similar to the one described in the above embodiment. Specifically, it is only required to substitute the fifth proportion corresponding to the path_x for Pᵢ, and the fourth proportion corresponding to the path_x for Qᵢ into the computing formula. The obtained KL divergence is the third KL divergence.

As an optional example, a fourth threshold is set, where a fourth threshold range is greater than a fourth KL threshold range.

It would be appreciated that, when the mapping relationship between the input data at the base period time point and the current period time point and the output data of the model is changed, the number of sample labels corresponding to the same path is also changed, leading to a change in the number of the sample labels of the same type. Therefore, there is a difference between distributions of the fifth proportions and the sixth proportions corresponding to respective types of sample labels. In the circumstance, the third KL divergence computed based on the fifth proportions and the sixth proportions corresponding to the respective types of sample labels can embody the distribution difference, and can be further used to characterize whether concept drift has occurred.

On the basis of the implementations provided in the aspects described above, the present disclosure can provide more implementations through further combinations.

It would be appreciated by those skilled in the art that, in the method according to the specific implementations, as described above, the order of the respective steps does not mean a strict execution order, without constituting any limitation to the implementation process, where the specific execution order of respective steps should be determined dependent on functions and possible internal logic thereof.

In addition to the model stability detection method provided by the above-described embodiments, embodiments of the present disclosure further provide a model stability detection apparatus, which will be detailed below with reference to the drawings. Since the apparatus according to these embodiments of the present disclosure is similar to the model stability detection method of the present disclosure in terms of principles for solving the problem, see the implementations of the method for details, where repeated contents are omitted herein.

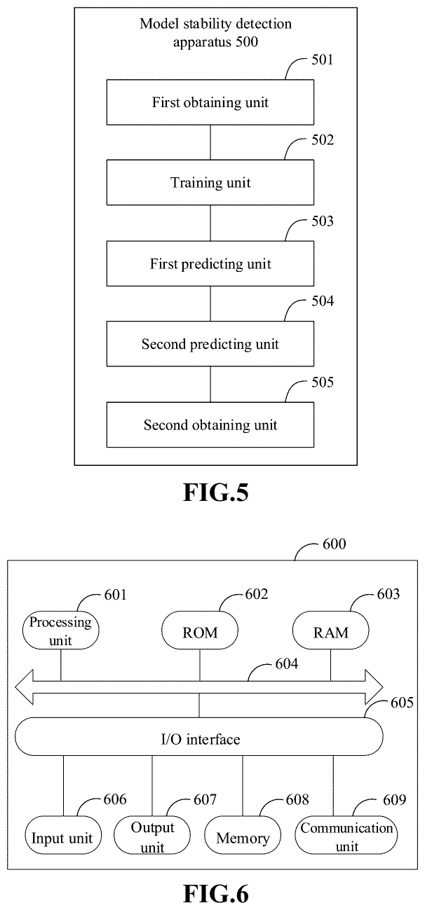

FIG. 5 illustrates a schematic diagram of a structure of a model stability detection apparatus provided by embodiments of the present disclosure. As shown therein, the model stability detection apparatus includes:
a first obtaining unit 501 for obtaining base period labeled samples and base period unlabeled samples at a base period time point, and current period unlabeled samples at a current period time point, the base period time point preceding the current period time point;
a training unit 502 for training a decision tree model based on the base period labeled samples, to obtain a base period decision tree model, the base period decision tree model comprising at least one path from a root node to a leaf node;
a first predicting unit 503 for applying the base period decision tree model to predict the base period unlabeled samples, obtaining a first sample statistic corresponding to each of the at least one path after the predicting, and forming a first set of numerical values by first sample statistics corresponding to respective paths in the at least one path;
a second predicting unit 504 for applying the base period decision tree model to predict the current period unlabeled samples, obtaining a second sample statistic corresponding to each of the at least one path after the predicting, and forming a second set of numerical values by second sample statistics corresponding to respective paths in the at least one path, the first sample statistic and the second sample statistic being of a same type; and
a second obtaining unit 505 for obtaining a first distribution difference result of the first set of numerical values and the second set of numerical values, and determining, in response to the first distribution difference result meeting a first preset condition, that data drift has occurred.

In a possible implementation, the second obtaining unit 505 includes:
a first calculating sub-unit for calculating a first KL divergence of the first set of numerical values and the second set of numerical values based on the first sample statistics corresponding to the respective paths in the first set of numerical values and the second sample statistics corresponding to the respective paths in the second set of numerical values; and
a first determining sub-unit for determining, in response to the first KL divergence meeting a first threshold range, that data drift has occurred.

In a possible implementation, the first predicting unit 503 is specifically used for:
calculating a first proportion corresponding to each of the at least one path after the predicting, and forming the first set of numerical values by first proportions corresponding to the respective paths, where the first proportion corresponding to the path is a proportion of a number of base period unlabeled samples passing through the path to a total number of the base period unlabeled samples after the predicting.

The second predicting unit 504 is specifically used for:
calculating a second proportion corresponding to each of the at least one path after the predicting, and forming the second set of numerical values by second proportions corresponding to the respective paths, where the second proportion corresponding to the path is a proportion of a number of current period unlabeled samples passing through the path to a total number of the current period unlabeled samples after the predicting.

In a possible implementation, the samples include input data features, and the apparatus further includes:
a calculating unit for calculating a difference between the first proportion and the second proportion corresponding to each of the at least one path;
a first determining unit for determining a path with the difference meeting a difference range as a first target path, and determining that the input data features associated with the first target path are related to the data drift.

In a possible implementation, the apparatus further includes:
a third obtaining unit for obtaining current period labeled samples at the current period time point;
a third predicting unit for applying the base period decision tree model to predict the base period labeled samples, where a first set of labels is formed by numbers of sample labels corresponding to the respective paths;
a fourth predicting unit for applying the base period decision tree model to predict the current period labeled samples, where a second set of labels is formed by numbers of sample labels corresponding to the respective paths after the predicting; and
a fourth obtaining unit for obtaining a second distribution difference result of the first set of labels and the second set of labels, and determining, in response to the second distribution difference result meeting a second preset condition, that concept drift has occurred.

In a possible implementation, the fourth obtaining unit includes:
a second calculating sub-unit for calculating a third proportion of the number of sample labels corresponding to each of the at least one path to a total number of the base period labeled samples;
a third calculating sub-unit for calculating a fourth proportion of the number of sample labels corresponding to each of the at least one path to a total number of the current period labeled samples;
a fourth calculating sub-unit for calculating a second KL divergence corresponding to each of the at least one path, based on the third proportion and the fourth proportion corresponding to each of the at least one path;
a selecting sub-unit for selecting a maximum KL divergence in second KL divergences corresponding to the respective paths; and
a second determining sub-unit for determining, in response to the maximum KL divergence meeting a second threshold range, that the concept drift has occurred.

In a possible implementation, the apparatus further includes:
a second determining unit for determining a second target path corresponding to the maximum KL divergence; and
a third determining unit for determining that input data features associated with the second target path are related to the concept drift if the maximum KL divergence meets a third threshold range

It is worth noting that the respective units in the embodiments can be specifically implemented with reference to the related description in the method embodiments as described above. The division of the units according to the embodiments of the present disclosure is only a logical function division, which may be a further type of division when implemented in practice. The respective functional units in the embodiments of the present disclosure may be integrated in a processing unit, or each unit may exist physically and separately, or two or more units may be integrated in one unit. For example, in the above-mentioned embodiments, the processing unit and the transmission unit may be the same unit, or may be different units. The integrated unit may be implemented in the form of hardware, or in the form of software functional units.

On the basis of the model stability detection method provided by the above method embodiments, the present disclosure provides an electronic device, including: one or more processors; a memory having one or more programs stored thereon, where the one or more programs, when executed by the one or more processors, cause the one or more processors to implement the model stability detection method according to any of the above embodiments.

FIG. 6 illustrates a schematic diagram of a structure of an electronic device 600 adapted to implement embodiments of the present disclosure. The terminal device according to the embodiments of the present disclosure may include, but is not limited to, a mobile terminal such as a mobile phone, a laptop computer, a digital broadcast receiver, a Personal Digital Assistant (PDA), a Portable Android Device (PAD, a tablet computer), a Portable Multimedia Player (PMP), an on-vehicle terminal (e.g. an on-vehicle navigation terminal) or the like, or a fixed terminal such as a digital TV, a desktop computer or the like. The electronic device as shown in FIG. 6 is only an example, without suggesting any limitation to the functions and the application range of the embodiments of the present disclosure.

As shown therein, the electronic device 600 may include a processing unit (e.g. a central processor, a graphics processor or the like) 601, which can execute various acts and processing based on programs stored in a Read-Only Memory (ROM) 602 or a program loaded from a storage unit 608 to a Random Access Memory (RAM) 603. RAM 603 stores therein various programs and data required for operations of the electronic device 600. The processing unit 601, the ROM 602 and the RAM 603 are connected to one another via a bus 604. An input/output (I/O) interface 605 is also connected to the bus 604.

Typically, the following units may be connected to the I/O interface 605: an input unit 606 including, for example, a touchscreen, a touch pad, a keyboard, a mouse, a camera, a microphone, an accelerometer, a gyroscope and the like; an output unit 607 including, for example, a Liquid Crystal Display (LCD), a loudspeaker, a vibrator and the like; a storage unit 608 including, for example, a tape, a hard drive and the like; and a communication unit 609. The communication unit 609 can allow wireless or wired communication of the electronic device 600 with other devices to exchange data. Although FIG. 6 shows the electronic device 600 including various units, it would be appreciated that not all of the units as shown are required to be implemented or provided. Alternatively, more or fewer units may be implemented or provided.

According to embodiments of the present disclosure, the processes described above with reference to the flowcharts may be implemented as computer software programs. For example, embodiments of the present disclosure include a computer program product comprising computer programs carried on a computer readable medium, where the computer programs containing program code are used for performing the methods as in the flowcharts. In those embodiments, the computer programs may be downloaded and installed from a network via the communication unit 609, or may be installed from the storage unit 608, or may be installed from the ROM 602. The computer programs, when executed by the processing unit 601, perform the above-described functions defined in the method according to the embodiments of the present disclosure.

The electronic device provided by the embodiments of the present disclosure and the model stability detection method provided by the embodiments described above belong to the same invention conception. For the details omitted in this embodiment, see the embodiments described above. The present embodiments have the same advantageous effects as the embodiments described above.

On the basis of the model stability detection method provided by the above method embodiments, the embodiments of the present disclosure further provide a computer readable storage medium having computer programs stored thereon, where the computer programs, when executed by a processor, cause the processor to implement the model stability detection method according to the embodiments as describe above.

It should be noted that the computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a Random-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a Local Area Network (LAN), a Wide Area Network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to perform steps of the model stability detection method as described above.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a Local Area Network (LAN) and a Wide Area Network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

The embodiments in the specification are described in a progressive way, where emphasis of the description of each embodiment is put on the differences from other embodiments, and for same or similar parts thereof, references can be mutually made to the other embodiments. Particularly, a system or apparatus embodiment is similar to a method embodiment and therefore described briefly. For related parts, references can be made to related descriptions in the method embodiment.

It should be understood that in the present disclosure, “at least one (item)” refers to one or more and “a plurality of” refers to two or more. The term “and/or” is used for describing an association relationship between associated objects, and represents that three relationships may exist. For example, “A and/or B” may represent the following three cases: only A exists, only B exists, and both A and B exist, where A and B may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, at least one of a, b, or c may indicate a, b, c, “a and b,” “a and c,” “b and c,” or “a, b, and c,” where a, b, and c may be singular or plural.

The relationship terms as used herein, for example, “first”, “second”, and the like, are only intended for distinguishing an entity or operation from a further entity or operation, but not necessarily require or imply that those entities or operations should have any of such actual relationships or orders. In addition, the terms “include”, “comprise”, or any other variant thereof are intended to cover a non-exclusive inclusion, such that a process, method, article, or device including a series of elements not only include those elements, but also cover other elements not listed explicitly, or further cover inherent elements of the process, method, article, or device. Unless specified otherwise, elements defined by the expression “including one . . . ” do not exclude presence of additional identical elements in the process, method, article, or device including those elements.

The steps of the method or algorithm described with reference to the embodiments disclosed herein may be implemented directly with hardware or software modules executed by a processor, or a combination thereof. The software modules may be arranged in a Random Access Memory (RAM), a memory, a Read-Only Memory (ROM), an electrically programmable ROM, an electrically erasable programmable ROM, a register, a hard disk, a removable disk, a CD-ROM, or a storage medium in any other form known in the art.

The previous description of the disclosed embodiments is provided to enable those skilled in the art to implement or apply the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

I/We claim:

1. A model stability detecting method, comprising:
obtaining base period labeled samples and base period unlabeled samples at a base period time point, and current unlabeled samples at a current period time point, the base period time point preceding the current period time point;
training a decision tree model based on the base period labeled samples, to obtain a base period decision tree model, the base period decision tree model comprising at least one path from a root node to a leaf node;
applying the base period decision tree model to predict the base period unlabeled samples, obtaining a first sample statistic corresponding to each of the at least one path after the predicting, and forming a first set of numerical values by first sample statistics corresponding to respective paths in the at least one path;
applying the base period decision tree model to predict the current period unlabeled samples, obtaining a second sample statistic corresponding to each of the at least one path after the predicting, and forming a second set of numerical values by second sample statistics corresponding to respective paths in the at least one path, the first sample statistic and the second sample statistic being of a same type; and
obtaining a first distribution difference result of the first set of numerical values and the second set of numerical values, and determining, in response to the first distribution difference result meeting a first preset condition, that data drift has occurred.

2. The method of claim 1, wherein obtaining the first distribution difference result of the first set of numerical values and the second set of numerical values, and determining, in response to the first distribution difference result meeting the first preset condition, that the data drift has occurred, comprise:
calculating a first KL divergence of the first set of numerical values and the second set of numerical values based on the first sample statistics corresponding to the respective paths in the first set of numerical values and the second sample statistics corresponding to the respective paths in the second set of numerical values; and
determining, in response to the first KL divergence meeting a first threshold range, that the data drift has occurred.

3. The method of claim 1, wherein obtaining the first sample statistic corresponding to each of the at least one path after the predicting, and forming the first set of numerical values by the first sample statistics corresponding to the respective paths, comprise:
calculating a first proportion corresponding to each of the at least one path after the predicting, and forming the first set of numerical values by first proportions corresponding to the respective paths, the first proportion corresponding to the path being a proportion of a number of base period unlabeled samples passing through the path to a total number of the base period unlabeled samples after the predicting; and
wherein obtaining the second sample statistic corresponding to each of the at least one path after the predicting, and forming the second set of numerical values by second sample statistics corresponding to the respective paths, comprise:
calculating a second proportion corresponding to each of the at least one path after the predicting, and forming the second set of numerical values by second proportions corresponding to the respective paths, the second proportion corresponding to the path being a proportion of a number of current period unlabeled samples passing through the path to a total number of the current period unlabeled samples after the predicting.

4. The method of claim 3, wherein the samples comprise input data features, and the method further comprises:
calculating a difference between the first proportion and the second proportion corresponding to each of the at least one path; and
determining a path with the difference meeting a difference range as a first target path, and determining that input data features associated with the first target path are related to the data drift.

5. The method of claim 1, further comprising:
obtaining current period labeled samples at the current period time point;
applying the base period decision tree model to predict the base period labeled samples, and forming a first set of labels by numbers of sample labels corresponding to the respective paths after the predicting;
applying the base period decision tree model to predict the current period labeled samples, and forming a second set of labels by numbers of sample labels corresponding to the respective paths after the predicting; and
obtaining a second distribution difference result of the first set of labels and the second set of labels, and determining, in response to the second distribution difference result meeting a second preset condition, that concept drift has occurred.

6. The method of claim 5, wherein obtaining the second distribution difference result of the first set of labels and the second set of labels, and determining, in response to the second distribution difference result meeting the second preset condition, that the concept drift has occurred, comprise:
calculating a third proportion of the number of sample labels in the first set of labels corresponding to each of the at least one path to a total number of the base period labeled samples;
calculating a fourth proportion of the number of sample labels in the first set of labels corresponding to each of the at least one path to a total number of the current period labeled samples;
calculating a second KL divergence corresponding to each of the at least one path, based on the third proportion and the fourth proportion corresponding to each of the at least one path;
selecting a maximum KL divergence in second KL divergences corresponding to the respective paths; and
determining, in response to the maximum KL divergence meeting a second threshold range, that the concept drift has occurred.

7. The method of claim 6, wherein the samples comprise input data features, and the method further comprises:
determining a second target path corresponding to the maximum KL divergence; and
determining that input data features associated with the second target path are related to the concept drift if the maximum KL divergence meets a third threshold range.

8. An electronic device, comprising:
one or more processors; and
a memory having one or more programs stored thereon,
wherein the one or more programs, when executed by the one or more processors, cause the one or more processors to implement a model stability detecting method comprising:
obtaining base period labeled samples and base period unlabeled samples at a base period time point, and current unlabeled samples at a current period time point, the base period time point preceding the current period time point;
training a decision tree model based on the base period labeled samples, to obtain a base period decision tree model, the base period decision tree model comprising at least one path from a root node to a leaf node;
applying the base period decision tree model to predict the base period unlabeled samples, obtaining a first sample statistic corresponding to each of the at least one path after the predicting, and forming a first set of numerical values by first sample statistics corresponding to respective paths in the at least one path;
applying the base period decision tree model to predict the current period unlabeled samples, obtaining a second sample statistic corresponding to each of the at least one path after the predicting, and forming a second set of numerical values by second sample statistics corresponding to respective paths in the at least one path, the first sample statistic and the second sample statistic being of a same type; and
obtaining a first distribution difference result of the first set of numerical values and the second set of numerical values, and determining, in response to the first distribution difference result meeting a first preset condition, that data drift has occurred.

9. The electronic device of claim 8, wherein obtaining the first distribution difference result of the first set of numerical values and the second set of numerical values, and determining, in response to the first distribution difference result meeting the first preset condition, that the data drift has occurred, comprise:
calculating a first KL divergence of the first set of numerical values and the second set of numerical values based on the first sample statistics corresponding to the respective paths in the first set of numerical values and the second sample statistics corresponding to the respective paths in the second set of numerical values; and
determining, in response to the first KL divergence meeting a first threshold range, that the data drift has occurred.

10. The electronic device of claim 8, wherein obtaining the first sample statistic corresponding to each of the at least one path after the predicting, and forming the first set of numerical values by the first sample statistics corresponding to the respective paths, comprise:
calculating a first proportion corresponding to each of the at least one path after the predicting, and forming the first set of numerical values by first proportions corresponding to the respective paths, the first proportion corresponding to the path being a proportion of a number of base period unlabeled samples passing through the path to a total number of the base period unlabeled samples after the predicting; and
wherein obtaining the second sample statistic corresponding to each of the at least one path after the predicting, and forming the second set of numerical values by second sample statistics corresponding to the respective paths, comprise:
calculating a second proportion corresponding to each of the at least one path after the predicting, and forming the second set of numerical values by second proportions corresponding to the respective paths, the second proportion corresponding to the path being a proportion of a number of current period unlabeled samples passing through the path to a total number of the current period unlabeled samples after the predicting.

11. The electronic device of claim 10, wherein the samples comprise input data features, and the method further comprises:
calculating a difference between the first proportion and the second proportion corresponding to each of the at least one path; and
determining a path with the difference meeting a difference range as a first target path, and determining that input data features associated with the first target path are related to the data drift.

12. The electronic device of claim 8, wherein the method further comprises:
obtaining current period labeled samples at the current period time point;
applying the base period decision tree model to predict the base period labeled samples, and forming a first set of labels by numbers of sample labels corresponding to the respective paths after the predicting;
applying the base period decision tree model to predict the current period labeled samples, and forming a second set of labels by numbers of sample labels corresponding to the respective paths after the predicting; and
obtaining a second distribution difference result of the first set of labels and the second set of labels, and determining, in response to the second distribution difference result meeting a second preset condition, that concept drift has occurred.

13. The electronic device of claim 12, wherein obtaining the second distribution difference result of the first set of labels and the second set of labels, and determining, in response to the second distribution difference result meeting the second preset condition, that the concept drift has occurred, comprise:
calculating a third proportion of the number of sample labels in the first set of labels corresponding to each of the at least one path to a total number of the base period labeled samples;
calculating a fourth proportion of the number of sample labels in the first set of labels corresponding to each of the at least one path to a total number of the current period labeled samples;
calculating a second KL divergence corresponding to each of the at least one path, based on the third proportion and the fourth proportion corresponding to each of the at least one path;
selecting a maximum KL divergence in second KL divergences corresponding to the respective paths; and
determining, in response to the maximum KL divergence meeting a second threshold range, that the concept drift has occurred.

14. The electronic device of claim 13, wherein the samples comprise input data features, and the method further comprises:
determining a second target path corresponding to the maximum KL divergence; and
determining that input data features associated with the second target path are related to the concept drift if the maximum KL divergence meets a third threshold range.

15. A non-transitory computer readable storage medium having a computer program stored thereon, wherein the computer program, when executed by a processor, implements a model stability detecting method comprising:
obtaining base period labeled samples and base period unlabeled samples at a base period time point, and current unlabeled samples at a current period time point, the base period time point preceding the current period time point;
training a decision tree model based on the base period labeled samples, to obtain a base period decision tree model, the base period decision tree model comprising at least one path from a root node to a leaf node;
applying the base period decision tree model to predict the base period unlabeled samples, obtaining a first sample statistic corresponding to each of the at least one path after the predicting, and forming a first set of numerical values by first sample statistics corresponding to respective paths in the at least one path;
applying the base period decision tree model to predict the current period unlabeled samples, obtaining a second sample statistic corresponding to each of the at least one path after the predicting, and forming a second set of numerical values by second sample statistics corresponding to respective paths in the at least one path, the first sample statistic and the second sample statistic being of a same type; and
obtaining a first distribution difference result of the first set of numerical values and the second set of numerical values, and determining, in response to the first distribution difference result meeting a first preset condition, that data drift has occurred.

16. The non-transitory computer readable storage medium of claim 15, wherein obtaining the first distribution difference result of the first set of numerical values and the second set of numerical values, and determining, in response to the first distribution difference result meeting the first preset condition, that the data drift has occurred, comprise:
calculating a first KL divergence of the first set of numerical values and the second set of numerical values based on the first sample statistics corresponding to the respective paths in the first set of numerical values and the second sample statistics corresponding to the respective paths in the second set of numerical values; and
determining, in response to the first KL divergence meeting a first threshold range, that the data drift has occurred.

17. The non-transitory computer readable storage medium of claim 15, wherein obtaining the first sample statistic corresponding to each of the at least one path after the predicting, and forming the first set of numerical values by the first sample statistics corresponding to the respective paths, comprise:
calculating a first proportion corresponding to each of the at least one path after the predicting, and forming the first set of numerical values by first proportions corresponding to the respective paths, the first proportion corresponding to the path being a proportion of a number of base period unlabeled samples passing through the path to a total number of the base period unlabeled samples after the predicting; and
wherein obtaining the second sample statistic corresponding to each of the at least one path after the predicting, and forming the second set of numerical values by second sample statistics corresponding to the respective paths, comprise:
calculating a second proportion corresponding to each of the at least one path after the predicting, and forming the second set of numerical values by second proportions corresponding to the respective paths, the second proportion corresponding to the path being a proportion of a number of current period unlabeled samples passing through the path to a total number of the current period unlabeled samples after the predicting.

18. The non-transitory computer readable storage medium of claim 17, wherein the samples comprise input data features, and the method further comprises:
calculating a difference between the first proportion and the second proportion corresponding to each of the at least one path; and
determining a path with the difference meeting a difference range as a first target path, and determining that input data features associated with the first target path are related to the data drift.

19. The non-transitory computer readable storage medium of claim 15, wherein the method further comprises:
obtaining current period labeled samples at the current period time point;
applying the base period decision tree model to predict the base period labeled samples, and forming a first set of labels by numbers of sample labels corresponding to the respective paths after the predicting;
applying the base period decision tree model to predict the current period labeled samples, and forming a second set of labels by numbers of sample labels corresponding to the respective paths after the predicting; and
obtaining a second distribution difference result of the first set of labels and the second set of labels, and determining, in response to the second distribution difference result meeting a second preset condition, that concept drift has occurred.

20. The non-transitory computer readable storage medium of claim 19, wherein obtaining the second distribution difference result of the first set of labels and the second set of labels, and determining, in response to the second distribution difference result meeting the second preset condition, that the concept drift has occurred, comprise:
calculating a third proportion of the number of sample labels in the first set of labels corresponding to each of the at least one path to a total number of the base period labeled samples;
calculating a fourth proportion of the number of sample labels in the first set of labels corresponding to each of the at least one path to a total number of the current period labeled samples;
calculating a second KL divergence corresponding to each of the at least one path, based on the third proportion and the fourth proportion corresponding to each of the at least one path;
selecting a maximum KL divergence in second KL divergences corresponding to the respective paths; and
determining, in response to the maximum KL divergence meeting a second threshold range, that the concept drift has occurred.
